(19) United States
(12) Patent Application Publication
(10) Pub. No.: US 2003/0037950 A1
(43) Pub. Date: Feb. 27, 2003

(54) Apparatus and methods for aircraft floor junction box installation

(76) Inventor: Guy A. Lambiaso, Garden Grove, CA (US)

Correspondence Address: Elizabeth D. Odell, Harness, Dickey & Pierce, P.L.C., Suite 400, 5445 Corporate Drive, Troy, MI, 48098-2683, US

(21) Appl. No.: 09/934,337

(22) Filed: Aug. 21, 2001

(51) Int. Cl. H01H 9/02

(52) U.S. Cl. 174/58

(57) ABSTRACT

A method for installing a junction box in a recess beneath floor paneling in an aircraft. From above the floor, the box is inserted into an opening in the floor paneling while at least one spring clip is depressed against a side of the box until the box is in a desired position. The spring clip(s) are released to retain the box in the desired position, wherein the floor paneling constrains the clip(s) while supporting at least one box support tab. The method can be used to install junction boxes for in-flight systems for which it is desired to make connections under the aircraft floor. Because the box is installed and/or removed from above the floor, wiring installation time is reduced and ease of maintenance is enhanced.

### FIELD OF THE INVENTION

The present invention relates generally to installation of wiring in aircraft and, more particularly, to apparatus and methods for installing a wiring junction box below an aircraft floor panel.

### BACKGROUND OF THE INVENTION

Wiring for aircraft passenger seat lighting and communication equipment typically is installed beneath the floors and/or sidewalls of the aircraft so that seated passengers have convenient yet safe access to such devices. Cabling installed beneath aircraft floor paneling typically extends in fore and aft directions relative to the aircraft, close to tracks upon which the passenger seats are affixed in rows. Wiring from passenger seat lights and, for example, back-of-seat telephones typically extends downward from the devices through the seats into below-floor junction boxes in which the wiring is connected to the fore-to-aft cabling. Such junction boxes are commercially available from AT&T Claircom and other companies.

Below-floor wiring connections typically are made from beneath the cabin floor, and the junction boxes also typically are installed from beneath the floor. Thus it can be difficult and time consuming to install commercially available junction boxes and/or to access the connections within such boxes. Such commercially available junction boxes can be installed from beneath aircraft floor paneling to provide access from above the floor paneling to an enclosed connection. It would be desirable not only to access the connection within such a box from above the floor, but also to be able to install such a box into a recess under the floor panel without having to access the box location from beneath the floor.

### SUMMARY OF THE INVENTION

In one preferred form, the present invention provides a method for installing a junction box in a recess beneath floor paneling in an aircraft. From above the floor, the box is inserted into an opening in the floor paneling while at least one spring clip is depressed against a side of the box until the box is in a desired position relative to the floor paneling. The spring clip(s) are released to retain the box in the desired position, wherein the floor paneling constrains the clip(s) while supporting at least one support tab affixed to the box. The above method can be used to install junction boxes for in-flight phone and video systems and for other systems for which it is desired to make connections under the floor of the aircraft. Because the box is installed and/or removed from above the floor, wiring installation time is reduced and ease of maintenance is enhanced.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a junction box installed in accordance with one embodiment of the present invention;

FIG. 2 is a side elevational view of a junction box installed in accordance with one embodiment of the present invention; and

FIG. 3 is a top plan view of the box shown in FIG. 1 with a gasket, strain relief member and cover removed.

### DETAILED DESCRIPTION OF THE PREFERRED EMBODIMENTS

The following description of the preferred embodiments is merely exemplary in nature and is in no way intended to limit the invention, its application, or uses. FIG. 1 is an exploded perspective view of a well known, commercially available junction box 10 installed, for example, in an aircraft in a recess 14 below a cabin floor panel 18 from above the floor panel 18 in accordance with one embodiment of the present invention. The box 10 is supported by a plurality of support tabs 22 that rest upon the floor panel 18. The recess 14 is near a seat track 26 upon which are affixed a row of passenger seats (not shown). Although six support tabs 22 are shown in FIG. 1, it is contemplated that a different number of tabs can be used in accordance with embodiments of the present invention. Additionally, a tab can be of different size and or orientation relative to the box than those shown in FIG. 1.

Inside the box 10 are connections (not shown in FIG. 1) between one or more wires or cables (not shown in FIG. 1) running in fore and aft directions relative to the aircraft and one or more seat row wires or cables (not shown in FIG. 1) connected, for example, to lights and telephones serving the row of passenger seats. A gasket 30 is overlaid upon the tabs 22, and a strain relief member 34 is overlaid upon the gasket 30. A cover 38 is overlaid upon the strain relief member 34 and covers the box 10. A raised area 42 of the cover 38 allows the wire(s) serving the seat row to extend out of the box 10 from the connection(s) inside the box. A retainer 46 of the strain relief member 34 prevents the seat row wire(s) from pulling out of the box 10.

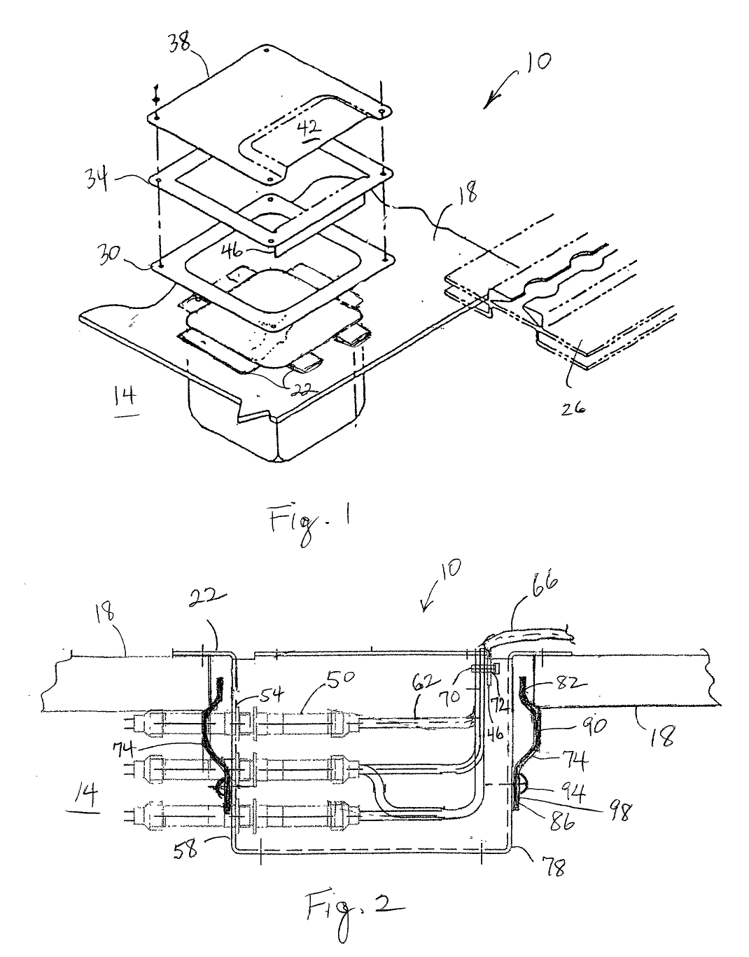

FIG. 2 is a side elevational view of the box 10 installed in the floor recess 14 in accordance with the present embodiment. Three connectors 50 are shown in FIG. 2 that extend into the box 10 from the recess 14 through holes 54 in a side 58 of the box. Wires 62 extend from the connectors 50 and are connected to seat row wires 66 by a tie-wrap connector 70 extending through a hole 72 in the retainer 46.

Two spring clips 74 are mounted to the box exterior, on opposing sides 58 and 78. Each clip 74 includes an upper arm 82, a lower arm 86 and a generally arcuate detent section 90 between the arms 82 and 86. The clips 74 are attached to the box 10 by adjustment screws 94 extending through slotted holes 98 in the lower arms 86 and respectively through the sides 58 and 78. It is contemplated that alternative devices, for example, pins and/or ratcheting, could be used to adjust the box 10 for insertion into and/or removal from the recess 14 as further described below. The clips 74 are attached to the box 10 such that the upper arms 82 can be depressed respectively against the sides 58 and 78 during installation or removal of the box 10 as further described below, yet are spaced apart from the box while not being depressed. The clips 74 are fabricated, for example, of steel. Although two spring clips 74 are shown in FIG. 2, it is contemplated that one clip 74 could be configured to allow insertion and removal of the box 10 as described herein. Additional embodiments can include more than two clips 74 and can include clips 74 mounted on more than two sides of the box.

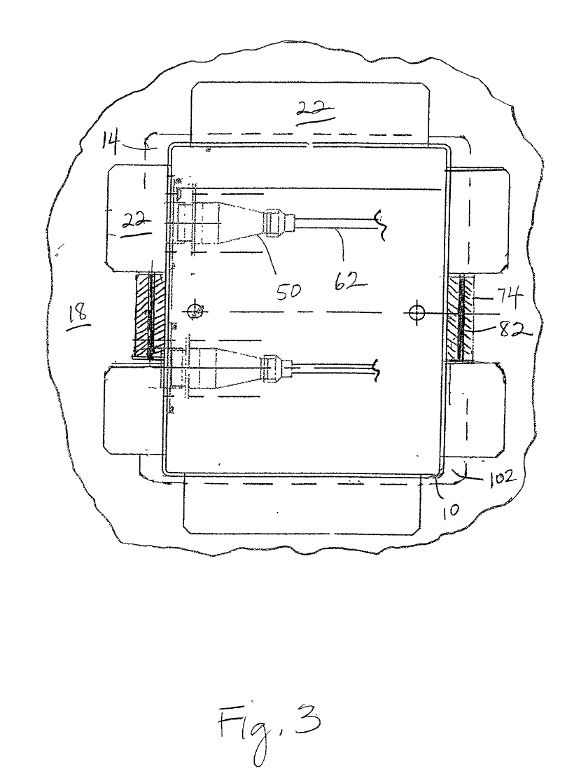

FIG. 3 is a top plan view of the box 10 with the gasket 30, strain relief member 34 and cover 38 removed. Two connectors 50 and wires 62 are partially shown in FIG. 3. Referring to FIGS. 2 and 3, the box 10 can be installed from above the floor in the following manner. The floor paneling 18 is cut away to form an opening 102 of a sufficient size to allow the box 10 to be inserted through the opening 102 into the recess 14. The opening 102 also is sufficiently tight to allow the floor panel 18 to constrain each spring clip 74 when the box 10 is in an installed position. The spring clips 74 are depressed toward the box 10, the box is inserted into the opening 102, and the support tabs 22 are brought to rest upon the floor paneling 18. The spring clips 74 are released and spring away from respective sides 58 and 78 and press against the floor paneling 18. The detents 90 and tension in the clips 74 prevent the box 10 from moving upward after it has been installed. Connections can be made in the box 10 from above the floor 18.

The box 10 can be removed from above the floor 18 when the upper arms 82 of the spring clips 74 are pressed toward the respective sides 58 and 78 and the box 10 is lifted from the recess 14. Positioning and/or tension of a spring clip 74 can be adjusted, for example, to allow the box 10 to fit relative to a given floor panel thickness. Adjustment can be made by loosening the adjustment screw 94 corresponding to the clip 74, moving the clip 74 up or down relative to the screw 94 within the leeway afforded by the slotted holes 98, and/or tightening the screw 94 relative to the box.

The above method and apparatus facilitate the installation, maintenance and removal of junction boxes for equipment such as in-flight phone and video systems. Because the box is installed from above the floor, it is not necessary to access the box from below the floor to install mechanical fasteners. Thus installation time is shortened, and maintenance of the box and the enclosed connections is made easier.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for installing a junction box in a recess beneath floor paneling in an aircraft, the method comprising the steps of:
from above the floor, inserting the box into an opening in the floor paneling while depressing at least one spring clip against a side of the box until the box is in a desired position relative to the floor paneling; and
releasing the at least one spring clip to retain the box in the desired position, wherein the floor paneling constrains the at least one clip while supporting at least one support tab affixed to the box.

2. The method of claim 1 further comprising the step of cutting an opening in the floor paneling that allows the box to be inserted and allows the floor paneling to constrain the box when the box is in the desired position.

3. The method of claim 1 further comprising the step of adjusting the at least one spring clip using an adjustment device.

4. The method of claim 3 wherein adjusting comprises tightening or loosening an adjustment screw relative to a slotted hole in the at least one spring clip.

5. The method of claim 3 wherein adjusting comprises adjusting for at least one of a floor paneling thickness and tension in the at least one spring clip.

6. The method of claim 1 further comprising the step of placing at least one box support tab onto the floor paneling to support the box.

7. The method of claim 1 further comprising the step of removing the box from the recess by depressing the at least one spring clip.

8. The method of claim 1 further comprising the step of cutting an opening that allows the box to be inserted and allows the floor paneling to constrain the box when the at least one spring clip is released.

9. The method of claim 1 further comprising the step of making connections in the box from above the floor paneling.

10. An apparatus for installing, from above floor paneling in an aircraft, a junction box through an opening in the floor paneling into a recess below the floor paneling, the apparatus comprising at least one spring clip mounted to an exterior side of the box, each of the clips comprising upper and lower arms and a central detent section between the arms, wherein the upper arm is depressible against the box to allow insertion of the box through the opening and the detent section is configured to constrain the box in the recess relative to the floor paneling.

11. The apparatus of claim 10 further comprising a pair of spring clips mounted on opposing exterior sides of the box.

12. The apparatus of claim 10 wherein the detent section and the floor paneling are configured to constrain the box.

13. The apparatus of claim 10 wherein the at least one spring clip further comprises an adjustment device configured to allow movement of the spring clip relative to the box.

14. The apparatus of claim 13 wherein the adjustment device comprises a slot through the lower arm and an adjustable screw extending through the slot and into the box.

15. The apparatus of claim 10 further comprising at least one support tab configured to support the box relative to the floor paneling.

16. A system on board an aircraft wherein wiring is installed under floor paneling of the aircraft, the system comprising at least one junction box for housing connections of the wiring, the box comprising at least one spring clip mounted to an exterior side of the box and configured:
while an upper arm of the at least one spring clip is depressed, to allow the box to be installed through an opening in the floor paneling from above the floor paneling; and
when the upper arm is released, to constrain the box relative to the floor paneling.

17. The system of claim 16 wherein the spring clip comprises an adjustment device configured to allow movement of the spring clip relative to the box.

18. The system of claim 17 wherein the adjustment device comprises a slot through a lower arm of the spring clip and an adjustable screw extending through the slot and into the box.

19. The system of claim 16 further comprising at least one support tab configured to support the box relative to the floor paneling.
